(19) United States
(12) Patent Application Publication
(10) Pub. No.: US 2006/0012705 A1
(43) Pub. Date: Jan. 19, 2006

(54) Glare hood for assembly on a freely set up display

(76) Inventor: Martijn Van Beenen, Amsterdam (NL)

Correspondence Address: MICHAELSON AND WALLACE;PARKWAY 109 OFFICE CENTER, 328 NEWMAN SPRINGS RD, P O BOX 8489, RED BANK, NJ, 07701, US

(21) Appl. No.: 10/512,105

(22) PCT Filed: Feb. 7, 2003
(86) PCT No.: PCT/NL03/00092

§ 371 Date: Aug. 22, 2005

(30) Foreign Application Priority Data
Apr. 22, 2002 (NL) 1020449

(51) Int. Cl. H04N 5/225

(52) U.S. Cl. 348/375

(57) ABSTRACT

A glare hood for assembly on a freely set up display, for instance display of a photo and/or video camera, wherein the glare hood (1) is at least partly manufactured from flexible material which, in a condition in which the glare hood (1) is assembled to the display (2), applies a clamping force to the display (2). The invention further provides a blank of a glare hood (1). In addition, the invention provides a method for fitting a glare hood on a display, wherein the glare hood (1) is detachably clamped on the display (2) while deforming a part of the glare hood (1).

The invention relates to a glare hood for assembly on a freely set up display, for instance a display of a photo and/or video camera.

Such a glare hood is known from U.S. Pat. No. 6,144,419. The known glare hood, also called the “Hoodman”, serves for reducing and/or preventing blinding of the display as a result of incident ambient light. Such blinding renders use of the display in bright ambient light difficult or even impossible, in particular in that the contrast disappears and the represented image can hardly or no longer be seen. The “Hoodman” to be attached to the display is designed for barring ambient light from the display so that the display remains well visible in, for instance, day light, bright sunlight and/or different light.

A drawback of the known glare hood is that it is of relative complex design and therefore is relatively difficult to manufacture. In addition, the known glare hood is relatively little durable due to its complicated construction and the associated difficult use. For instance, for the purpose of use, the known glare hood is to be attached to the display in a relatively complicated manner, in particular by attaching different parts of the glare hood with a number of Velcro tape connections to the display and to each other. In addition, the display may be damaged when, after use, the glare hood is detached from the display again, in that the attachment between the glare hood and the display is relatively hard to disengage. Moreover, due to its construction, the known glare hood is relatively expensive. Another drawback is that after assembly, the known glare hood proves not to be in proper abutment with the display, so that ambient light can undesirably reach the display via slits present between the hood and the display. Further, the known glare hood is relatively unattractive from an esthetic point of view.

The present invention contemplates a glare hood of the type described in the preamble, which can be used in a relatively simple and easy manner.

According to the invention, to this end, the glare hood is characterized in that the glare hood is at least partly manufactured from material flexible such that during use, at least in assembled condition, the glare hood applies a clamping force to the display.

This glare hood can be fitted to the display relatively rapidly, simply by clamping the glare hood on the display. The clamping force required to that end is simply provided by the flexible material of the glare hood. Therefore, use of separate attachment means for the purpose of fitting the glare hood to the display is superfluous. As the glare hood is clamped on the display, the hood can easily maintain a desired position of use. Further, the glare hood can be of relatively simple design, so that the glare hood can be manufactured relatively inexpensively and is relatively durable.

An additional advantage of the glare hood according to the invention is that it can abut against the display relatively tightly and hence can form an attractive unit. In particular, after assembly, the glaze hood seems to form an integral part of the display.

Preferably, the glare hood is manufactured from a relatively light material, for instance to prevent a display-retaining arm, extending between the display and an apparatus provided therewith for holding the display, from overloading. Preferably, the flexible material comprises a relatively form-retaining material. In particular, the flexible material comprises rubber, for instance a synthetic rubber. This rubber material is relatively light-weight and inexpensive. Further, this material can offer the display provided with the glare hood relatively good protection, for instance protection against bumping, falling and/or other undesired mechanical influences. Rubber, in particular synthetic rubber, for instance silicone rubber and/or neoprene®, is relatively durable, flexible, resilient (protective), rough, and light-proof, which, for the use and functioning of the glare hood, are advantageous properties. The flexible material can be designed in various colors, for instance in the color of the display. An advantageous color of the flexible material is matt black in view of the prevention of undesired light reflection. In a simple manner, the glare hood can substantially completely be made of the flexible material. Moreover, the glare hood can be provided wholly or partly in a blank. In that case, the user can simply form the glare hood from the blank.

According to a preferred embodiment of the invention, the glare hood is provided with at least one recess for sliding-in the display.

Thus, the glare hood can simply—and therefore rapidly—be slid onto the display. During sliding onto the display, the flexible material can deform for the purpose of giving the desired clamping force to the display. Further, it is advantageous when the glare hood is provided with relatively thick walls of a relatively resilient material, for instance the rubber mentioned, for protection of the display received in the recess. On the other side, the glare hood can be provided with relatively thin walls so that the hood can be designed to be relatively light-weight and inexpensive.

Further elaborations of the invention are described in the subclaims. Presently, the invention will be clarified with reference to an exemplary embodiment and the drawing. In the drawing:

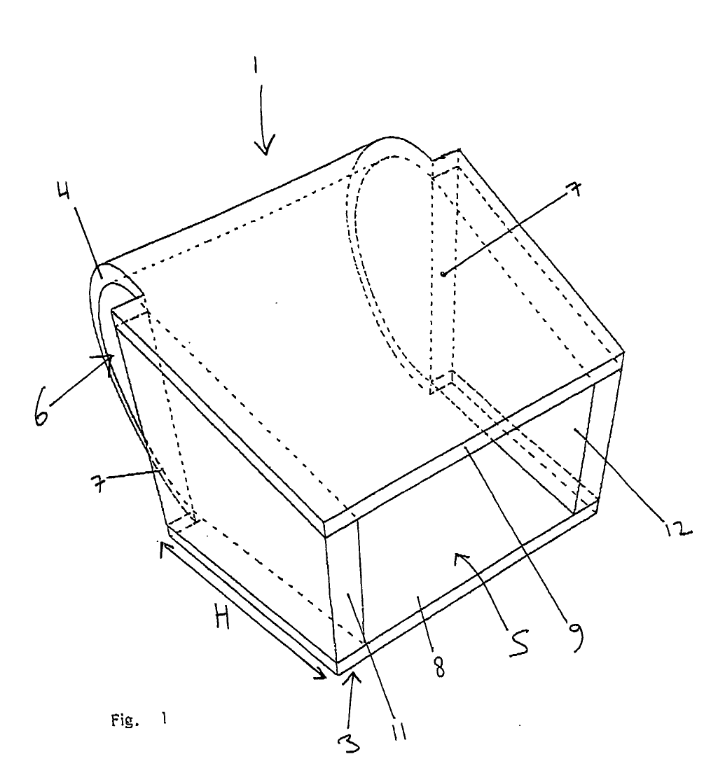

FIG. 1 shows a perspective view of a first exemplary embodiment of the invention;

FIG. 2 shows a blank of the exemplary embodiment represented in FIG. 1;

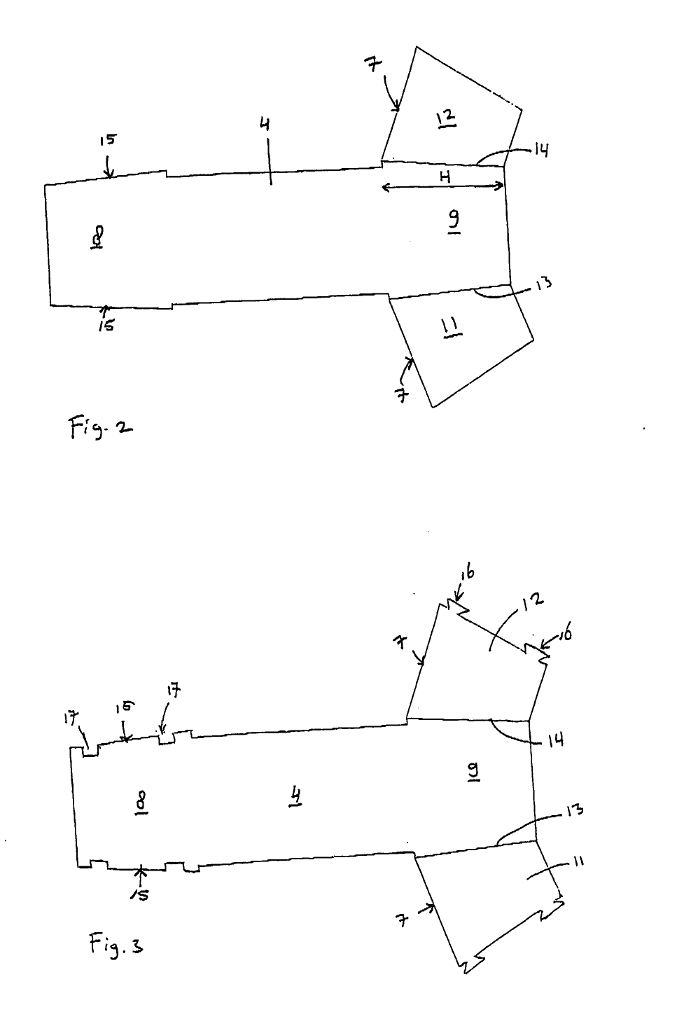

FIG. 3 shows a blank of an alternative exemplary embodiment of the invention;

FIG. 4 shows a perspective drawing of a video camera;

FIG. 5 shows a similar drawing as FIG. 4, wherein a glare hood according to the invention has been fitted onto the display of the camera; and

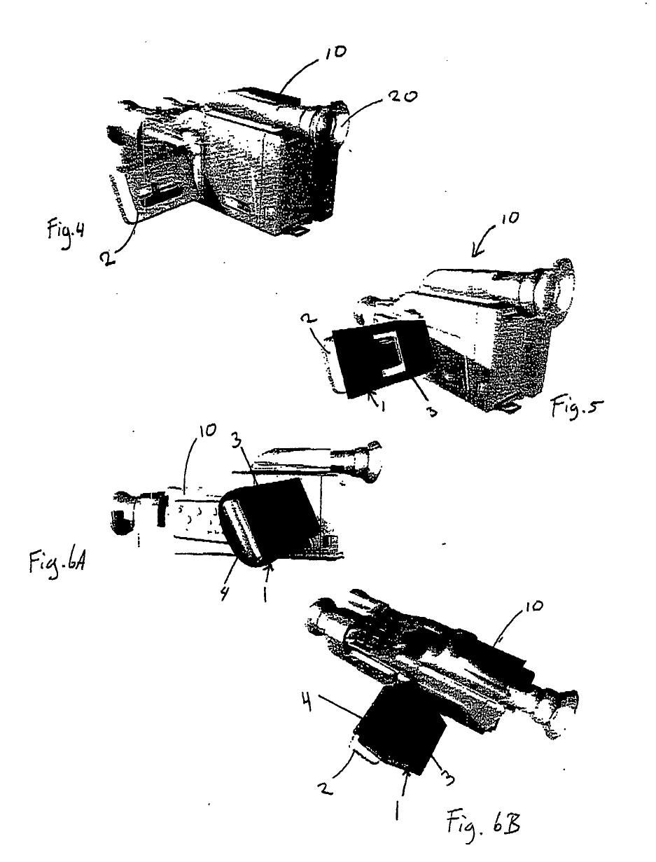

FIGS. 6a-6b show, in side view and top plan view, respectively, the camera with glare hood represented in FIG. 5.

FIG. 1 shows a first exemplary embodiment of a glare hood 1 for a freely set up display, for instance a display 2 of a video camera 10 represented in FIG. 4. The use of the glare hood 1 is represented in FIGS. 5, 6. The glare hood 1 is mounted on the display 2 of the camera 10 for preventing blinding of the display 2, so that the display 2 is well visible to the user of the video camera. Thus, a user can use the display 2 in a comfortable manner when filming, taking photos and playing earlier recorded recordings, without having to hold one eye against the relatively small viewfinder 20 of the camera.

In the present exemplary embodiment, the glare hood 1 is manufactured entirely from flexible material, which applies a clamping force to the display 2 with the glare hood 1 in assembled condition on the display 2. Due to this clamping force, the glare hood 1 can be fitted on the display 2 and be taken therefrom in a simple manner.

As follows from FIGS. 1, 5 and 6, the glare hood 1 is provided with a recess 6 for sliding the display 2 therein. To this end, the hood 1 comprises a tubular part 3 and, connected to the tubular part 3, a flexible wall part 4, bent in non-mounted condition. Together with an end face of the tubular part 3, the flexible wall part 4 bounds the recess 6 mentioned. The display 2 can be included in this recess 6 while deforming the flexible wall part 4. What is thus achieved in a simple manner, is that the glare hood 1 in the condition of use represented in FIG. 5, automatically applies the clamping force to the display 2. As shown in FIG. 6B, the flexible wall part 4 has a length such that it extends along virtually the entire rear side of the display 2 remote from the tube 3. In this manner, the flexible wall part 4 can offer protection to this display rear side. Moreover, the wall part extends over substantially the entire upper and lower side of the display. Therefore, the flexible wall part 4 prevents light incidence on the display 2 both at the display upper side and display lower side.

The tubular part 3 of the glare hood 1 tapers from the side of the flexible wall part 4 in a direction away from the display 2. The tubular part 3 comprises two first sidewalls 8, 9 extending opposite each other, and two sidewalls 11, 12 extending at right angles therebetween and opposite to each other (see FIG. 1). The walls 8, 9, 11, 12 surround a viewing space S via which a user—after assembly of the glare hood 1—can read the display. The flexible wall part 4 of the glare hood 1 connects the two opposite first sidewalls 8, 9 of the tubular part 3 simply integrally and therefore relatively sturdily to each other.

As shown by the Figures, edges 7 of the end face of the tubular part 3 extend substantially in one plane. Therefore, the glare hood 1 is arranged, at least after assembly, to abut substantially air-tightly by those edges 7 against a substantially flat surface of the display 2. Thus, the glare hood 1 can prevent blinding of the display 2 due to sideways ambient light in a highly effective manner. This mutual abutment of glare hood 1 and display 2 is further promoted by the clamping force between the glare hood 1 and the display 2, as in the present exemplary embodiment, this clamping force presses the tube 3 by the edges 7 against the display 2. Further, the glare hood 1 can protect the display 2 well against moisture, for instance rain, and/or dust from surroundings, in particular due to the proper abutment between the tube 3 and the display and in that the display 2 is included in the recess 6 of the hood 1.

Preferably, the glare hood 1 is provided—after assembly—with a rough surface facing the display 2, for instance the inside surface of the flexible wall part 4 and/or the surfaces of the edges 7 of the end face of the tube 3. As a consequence, undesired sliding of the mounted glare hood 1 can be prevented.

Moreover, the tubular part 3 preferably has a height H such that the display 2 can be touched with the fingers via the viewing space S, at least with the glare hood 1 in assembled condition. In this manner, the glare hood 1 has sufficient height, but is not unnecessarily high, for preventing blinding of the display. Due to the height H of the tubular part, moreover, fingers can reach sufficiently far into the tube 3 of the glare hood 1 for, near the display 2, pulling the hood 1 at least by applying a force to one of the first sidewalls 8, 9, for sliding the hood on and from the display 2. Further, the glare hood 1 can thus be used in combination with a display operable by touch without hindering the operation of that screen.

Preferably, the glare hood 1 according to the first exemplary embodiment is manufactured from relatively rigid, at least resilient material from the view point of durability and for offering a good protection against bumping, falling and/or other. The rubber mentioned is an example of such rigid material. However, to the skilled person it is clear that various other materials can be used, which materials can also offer the properties referred to. In particular, the thickness of at least some of the walls 4, 8, 9, 11,12 of the glare hood 1 is in the range of approximately 5-20 mm. With such thicknesses, the resilient walls can absorb undesired mechanical forces well for protecting the display 2. However, the walls of the glare hood 1 can also be manufactured from thicker or thinner material. The wall thickness can for instance be in the range of approximately 1-5 mm, in particular for saving material.

FIG. 2 shows a blank of the glare hood 1 according to the first exemplary embodiment. The blank comprises the flexible wall part 4, as well as the tubular part 3 which is formed from the first sidewalls 8, 9, and the second sidewalls 11, 12. Via lines 13, 14, the second sidewalls 11, 12 extend on longitudinal sides of a first tube sidewall 9. These lines 13, 14 can for instance comprise disconnecting lines, in particular cutting lines, tearing lines, perforation lines or the like, so that first, the second sidewalls 11, 12 can be separated from that tube sidewall 9 before these walls 11, 12 are provided at right angles between the other sidewalls 8, 9 for the purpose of forming the glare hood 1. Another possibility is that the second sidewalls 11, 12 are pivoted along those lines 13, 14, to then be attached to longitudinal edges 15 of the other tube sidewall 8. Mutual attachment of the various wall parts 8, 9, 11, 12 of the blank can be carried out in different manners, for instance in an undetachable manner by means of a glue connection so that the glare hood 1 needs only be assembled once, and/or in a detachable manner, for instance with snap connections or Velcro tape so that, after use, the glare hood 1 can simply be returned to an easily storable form.

FIG. 3 shows a blank of a second exemplary embodiment of the glare hood 1. Here, the two walls 11, 12 are connected to the tube sidewall 9 so as to be pivotable via folding lines 13, 14. Free longitudinal edges of the second walls 11, 12 are provided with dovetailed connecting lips 16 for cooperation with dovetailed connecting recesses 17 provided in the longitudinal edges 15 of the other tube sidewall 8. For the purpose of forming the glare hood 1, the first walls 8, 9 and the second walls 11, 12 can be moved towards each other, or pivoted towards each other, respectively, so that the tube 3 represented in FIG. 1 is formed. The connecting lips 16 are then simply inserted into the respective recesses 17 in order that the glare hood retains its form of use. After use, the glare hood 1 can simply be returned to the flat condition represented in FIG. 3, for instance for the purpose of transport and/or storage thereof.

It is self-evident that the invention is not limited to the exemplary embodiments described. Various modifications are possible within the framework of the invention as set forth in the following claims.

For instance, the glare hood 1 can be destined for use with one or more displays and/or LCD-screens of amateur, semi-professional and professional equipment, for example Hi8 cameras, DV and DVCAM videocameras, digital photo cameras. The glare hood can also be intended for displays of route planners, pocket computers, mobile phones, electronic calendars and the like. As a rule, such displays are relatively small. However, the glare hood 1 can also be arranged for use with larger displays, for instance of laptops and/or free standing plasma screens.

In addition, the glare hood can be manufactured wholly or partially from the flexible material mentioned. The flexible material can comprise different materials, for instance one or more suitable plastics, foam material, flexible metal and/or alloy, natural and/or synthetic rubber, cellular rubber, the silicone rubber mentioned and/or neoprene®, and/or a combination of these and/or other materials.

Further, the glare hood 1 is preferably designed to be wholly or partially black, however, the hood 1 can also be provided with one or more colors. For instance, the outside of the glare hood can, for instance, be substantially of the same color as an outside of the respective display and/or a respective camera, while an inside of the glare hood has a different color, for instance matt black or matt gray.

Furthermore, the clamping force can be effected, for instance, by spring means, which spring means are arranged for moving a moveable wall part and a tubular part 3 towards each other for clamping the display 2 therebetween. In that case, the moveable wall part can for instance be pivotally and/or integrally connected to an edge of the tubular part 6 of the glare hood in order that the glare hood can be fitted on the display in a simple manner, in particular by clampingly suspending the glare hood from the display 2.

In addition, the tubular part 3 can comprise different forms and it can taper or not taper.

Further, in unassembled condition, the flexible wall part can be substantially bent or, conversely, not bent. In the latter case, in the assembled condition, that wall part can, for instance, be brought into an at least partly bent position for effecting a clamping force on the display.

Further, the glare hood can be manufactured in various sizes for use with displays of various types and sizes.

The tubular part 3 can further have different heights H, for instance a height H such that fingers can no longer touch the display via the viewing space S.

The glare hood 1 can be manufactured in many ways, for instance by means of a suitable blank.

Further, the glare hood can, for instance, be formed partly, preferably completely by inserting a curable material and/or curable composition into a suitable mold cavity and having it cure therein for forming this glare hood part, at least partly. Preferably, the material and/or composition to be inserted into the mold cavity comprises, at least after its curing, the mentioned flexible material of the glare hood. The mold cavity mentioned to be used in this method is for instance formed for substantially forming the entire glare hood. The mold cavity can, for instance, be provided in a mold in a simple manner. An advantage of this method is that with it, the glare hood can directly be manufactured in the desired shape, without, for instance, to that end first a glare hood blank needing to be made, which blank is to be brought in the final shape by a user. Another advantage of this method is that it enables a relatively large number of such glare hoods to be manufactured relatively rapidly and in a relatively inexpensive manner.

1. A glare hood for assembly on a freely set up display, for instance a display of a photo and/or video camera, wherein the glare hood (1) is at least partly manufactured from flexible material which, in a condition in which the glare hood (1) is assembled to the display (2), applies a clamping force to the display (2).

2. A glare hood according to claim 1, wherein the glare hood (1) is provided with at least one recess (6) for sliding the display (2) into.

3. A glare hood according to claim 2, wherein said recess (6) is at least partly bounded by said flexible material.

4. A glare hood according to claim 1, which glare hood (1) comprises a tubular part (3) and a flexible wall part (4) connected to the tubular part (3), which wall part (4), together with an end face of the tubular part (3) bounds a recess (6) in which a said display (2) can be included while deforming the flexible wall part (4).

5. A glare hood according to claim 4, wherein the flexible wall part, in unassembled condition, is bent.

6. A glare hood according to at least claim 4, wherein edges (7) of the end face of the tubular part (3) are arranged for abutment, at least after assembly, with the display (2).

7. A glare hood according to at least claim 4, wherein said flexible wall part (4) interconnects two opposite walls (8, 9) of said tubular part (3).

8. A glare hood according to at least claim 4, wherein the tubular part (3) tapers from the side of the flexible wall part (4).

9. A glare hood according to claim 1, wherein the flexible material comprises rubber, for instance a synthetic rubber.

10. A glare hood according to at least claim 9, wherein said flexible material comprises neoprene®.

11. A glare hood according to at least claim 9, wherein said flexible material comprises silicone rubber.

12. A glare hood according to claim 1, wherein the flexible material is black.

13. A glare hood according to at least claim 4, wherein the tubular part (3) has a height (H) such that the display can be touched by the fingers, at least with the glare hood in assembled condition.

14. A glare hood according to claim 1, provided—after assembly—with a rough surface facing the display (2).

15. A glare hood according to claim 1, which hood (1) consists substantially of said flexible material.

16. A blank of a glare hood (1) according to at least claim 1.

17. A blank according to claim 16, provided with folding lines for folding the blank into the glare hood.

18. A blank according to claim 16, wherein the blank is provided with attachment parts (16, 17) for retaining the glare hood (1) made from the blank in a position of use.

19. A blank according to at least claim 16, wherein the blank is provided with disconnecting lines, for instance cutting lines, perforation lines and/or tearing lines, for separating different wall parts of the glare hood (1) from each other before these wall parts are attached to each other for forming the glare hood (1).

20. A method for fitting a glare hood onto a display, wherein the glare hood (1) is detachably clamped on the display (2) while deforming a part of the glare hood (1).

21. A method according to claim 20, wherein the display (2) is slid into a recess (6) of the glare hood (1).

22. A method for manufacturing a glare hood according to at least claim 1, wherein at least a part of the glare hood is formed, by inserting a curable material and/or curable composition into a mold cavity and having it cure therein to form the glare hood part.

23. A method according to claim 22, wherein said mold cavity is formed for forming substantially the entire glare hood.

24. A mold, evidently intended and suitable for use in a method according to claim 22, which mold comprises said mold cavity.
